(19) United States
(12) Patent Application Publication
(10) Pub. No.: US 2011/0138236 A1
(43) Pub. Date: Jun. 9, 2011

(54) APPARATUS AND METHOD FOR PROVIDING VISUAL INTERFACE FOR INFORMATION OF ERROR GENERATED IN MULTITHREAD TESTING

(75) Inventors: Jin-Man PARK, Seoul (KR); Sung-Do MOON, Seongnam-si (KR); Jung-Gyu PARK, Yongin-si (KR)

(73) Assignee: SAMSUNG ELECTRONICS CO., LTD., Suwon-si (KR)

(21) Appl. No.: 12/896,771

(22) Filed: Oct. 1, 2010

(30) Foreign Application Priority Data
Dec. 9, 2009 (KR) 10-2009-0121899

(51) Int. Cl. G06F 11/07; G06F 3/01

(52) U.S. Cl. 714/57; 714/E11.025

(57) ABSTRACT

A visual interface providing method for efficiently providing information about errors occurring in a multi-thread operation state. Error log information about at least one error generated during multi-thread processing of program code may be generated. The error log information may be converted into a markup language file according to a predetermined document type definition that specifies at least one information item used for a visual interface with respect to an error. The visual interface may be provided by rendering the markup language file, wherein the visual interface includes thread information including at least one of general information about at least one thread in which an error has occurred and error information about the error, and time information about a time period during which the at least one thread is executed.

### CROSS-REFERENCE TO RELATED APPLICATION(S)

This application claims the benefit under 35 U.S.C. §119(a) of Korean Patent Application No. 10-2009-0121899, filed on Dec. 9, 2009, the entire disclosure of which is incorporated herein by reference for all purposes.

### BACKGROUND

1. Field

The following description relates to a visual interface, and more particularly, to an apparatus and method for providing a visual interface for displaying information of errors generated in multithread testing.

2. Description of the Related Art

Recently, the need for devices which can process a number of tasks in a parallel manner in real time is increasing. To process multiple tasks efficiently, a multithread processing method has been adopted.

In multithreading, multiple threads share resources of a processor (or a core) such as a central processing unit (CPU) and the multiple threads are executed simultaneously to perform a task. In a single-core processor, the multithreading is utilized to increase the entire system usage. In a multi-core processor, the multithreading is used to implement parallelism, increasing the system utilization and execution time.

In multithreading, errors such as data race and memory leakage may occur inherently. Data race occurs when two or more threads access the same address of a memory in a single-core processor. A memory leak takes place when a memory that is requested by a program cannot be released. To detect the above errors, various multithread error checking tools have been introduced by a number of vendors. However, such multithread error checking tools only provide text-based error and warning information, and thus are less intuitive. Hence retracing must be performed in order to fully comprehend the source of errors, and accordingly error debugging is difficult.

### SUMMARY

In one general aspect, there is provided a method of providing information regarding an error generated in multiple threads, the method including: generating error log information about at least one error generated during multi-thread processing of program code, converting the error log information into a markup language file according to a predetermined document type definition that specifies at least one information item used for a visual interface with respect to an error, and providing the visual interface by rendering the markup language file, the visual interface including: thread information including at least one of general information about at least one thread in which an error has occurred and error information about the error, and time information about a time period during which the at least one thread is executed.

The method may include that the predetermined document type definition includes at least one information item which indicates: the general information of a thread or the error information about an error that has occurred in a thread, and linkage information to link with another markup language file.

The method may include that the general information includes at least one of: thread identification information, thread lifetime and identification information of a processor to which a thread is allocated, at least one memory address that a thread uses, a variable name that indicates the memory address, call stack information, and information of a relationship between threads.

The method may include that the error information includes at least one of a type of error in a thread, error occurrence time, and a memory address on which an error has occurred.

The method may include that the providing of the visual interface includes:

arranging the thread information along a first axis, the general information including information about at least one thread in which the error has occurred, and

providing the time information on a second axis which is different from the first axis, the time information including information about a time period during which the at least one thread is executed.

The method may further include: providing one or more indicators, each of which provides the information item regarding at least one thread in which the error has occurred, and which can be selected according to a user input, and providing another visual interface by loading a markup language file including specified information of the information item indicated by the indicator in response to a user input signal for selecting one of the one or more indicators, the specified information being linked with the selected indicator.

The method may include that the one or more indicators include at least one of a first indicator indicating a memory address on which the error has occurred, a second indicator indicating a time when the error occurred in the thread, and a third indicator indicating identification information of a processor in which the thread is executed.

The method may further include displaying information of at least one of other threads that share the memory address with the thread, in response to a user input signal for selecting the first indicator.

The method may further include: displaying a function including the error and another function that has invoked the function, in response to a user input signal for selecting the second indicator, and in response to the other function that has invoked the function being called by a different thread, displaying information of the different thread.

The method may further include displaying information of at least one of other threads that are executed in the processor, in response to a user input signal for selecting the third indicator.

In another general aspect, there is provided an apparatus for providing information of an error generated in multiple threads, the apparatus including: an error checking unit configured to generate error log information about at least one error generated during multi-thread processing of program code, a markup language file generating unit configured to convert the error log information into a markup language file according to a predetermined document type definition specifying at least one information item used for a visual interface with respect to an error, and a visual interface providing unit configured to provide the visual interface by rendering the markup language file, the visual interface including thread information including at least one of: general information about at least one thread in which an error has occurred and error information about the error, and time information about a time period during which the at least one thread is executed.

The apparatus may include that the predetermined document type definition includes at least one information item configured to indicate: the general information of a thread or the error information about an error that has occurred in a thread, and linkage information to link with another markup language file.

The apparatus may include that the visual interface providing unit is further configured to: provide one or more indicators, each of which being configured to provide the information item regarding at least one thread in which the error has occurred, and which can be selected according to a user input, and provide another visual interface by loading a markup language file including specified information of the information item indicated by the indicator in response to a user input signal for selecting one of the one or more indicators, the specified information being linked with the selected indicator.

The apparatus may include that the one or more indicators include at least one of: a first indicator configured to indicate a memory address on which the error has occurred, a second indicator configured to indicate a time when the error occurred in the thread, and a third indicator configured to indicate identification information of a processor in which the thread is executed.

The apparatus may include that the visual interface providing unit is further configured to display information of at least one of other threads that share the memory address with the thread, in response to a user input signal for selecting the first indicator.

The apparatus may include that the visual interface providing unit is further configured to: display a function including the error and another function that has invoked the function, in response to a user input signal for selecting the second indicator, and in response to the other function that has invoked the function being called by a different thread, display information of the different thread.

The apparatus may include that the visual interface providing unit is further configured to display information of at least one of other threads that are executed in the processor, in response to a user input signal for selecting the third indicator.

In another general aspect, there is provided a computer-readable information storage medium storing a program that, when executed, causes the computer to perform a method, including: generating error log information about at least one error generated during multi-thread processing of program code, converting the error log information into a markup language file according to a predetermined document type definition that specifies at least one information item used for a visual interface with respect to an error, and providing the visual interface by rendering the markup language file, the visual interface including: thread information including at least one of general information about at least one thread in which an error has occurred and error information about the error, and time information about a time period during which the at least one thread is executed.

Other features and aspects will be apparent from the following detailed description, the drawings, and the claims.

### BRIEF DESCRIPTION OF THE DRAWINGS

FIG. 1 is a diagram illustrating an example of a basic configuration of a visual interface for providing information of errors generated in multiple threads.

FIG. 2 is a diagram illustrating an example of a visual interface screen for providing information of errors generated in multiple threads.

FIG. 3 is a diagram illustrating an example of a visual interface screen which is additionally provided in response to selecting a first indicator shown in FIG. 2.

FIG. 4 is a diagram illustrating an example of a visual interface screen which is additionally provided in response to selecting a second indicator shown in FIG. 2.

FIG. 5 is a diagram illustrating an example of a visual interface screen which is additionally provided in response to selecting the third indicator shown in FIG. 2.

FIG. 6 is a diagram illustrating an example of a structure of a visual interface providing apparatus for providing information of errors generated in multiple threads.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, descriptions of well-known functions and constructions may be omitted for increased clarity and conciseness.

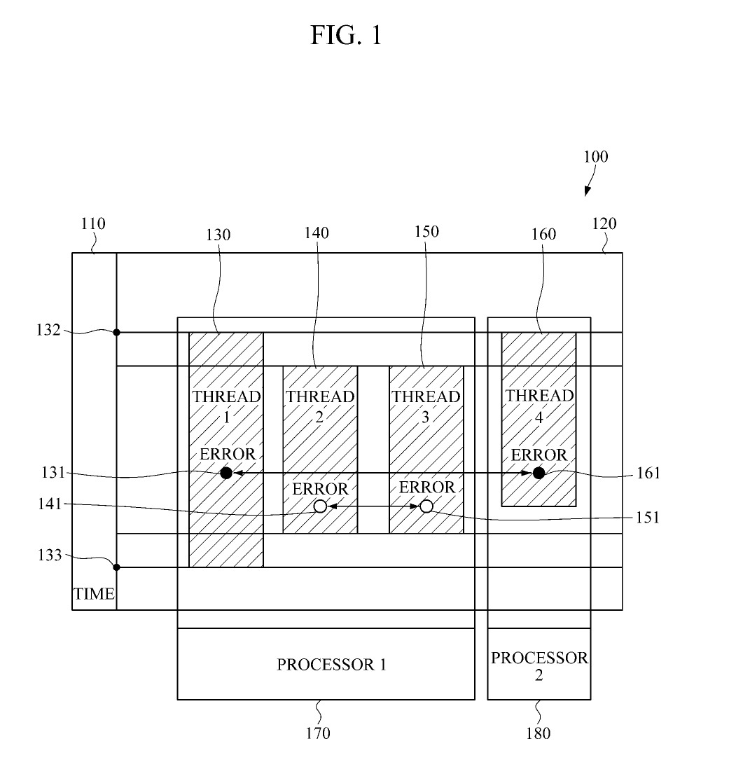

FIG. 1 illustrates an example of a basic configuration of a visual interface for providing information of errors generated in multiple threads.

A visual interface 100 for providing error information generated in multiple threads may include a time information providing region 110 and a thread information providing region 120. In addition, the visual interface 100 arranges at least one piece of thread information along a first axis that corresponds to an X axis of the visual interface 100 and provides time information on a second axis that is different from the first axis. The thread information is information of a thread in which an error has occurred, and the time information is information about a time period during which the thread is executed. Referring to FIG. 1, information about the thread in which an error has occurred may be displayed on the first axis which is a horizontal axis of the thread information providing region 120, and the time information related to the thread may be displayed on the second axis which is a vertical axis of the time information providing region 110.

Individual thread information may include general information of each thread and error information of an error that occurs in the thread. The general information of a thread may include at least one of thread identification information, thread lifetime, and identification information of a processor to which the thread is allocated. For example, the thread lifetime may be represented by the starting time of a thread and the ending time of a thread.

Additionally, the general information of a thread may further include at least one of: at least one of memory addresses that the thread uses; a variable name that indicates the memory address; call stack information; and information of relationship between threads. For example, the call stack information includes information of a subroutine of a program executed, that is, a call stack indicating a stack data structure that dynamically stores data related to the call relationship between functions. The relationship between threads provides information of whether two or more threads are in a parent-child relationship or are siblings.

The error information may include at least one of a type of an error in a thread, error occurrence time and a variable name (for example, a memory address and a location of a source code on which the error occurs) involved with the error occurrence, and call stack information at time of error occurrence. The type of an error may include data race, a memory leak, null free, and the like, and other types of errors may also be included.

The pieces of thread information of threads 130, 140, 150, and 160, each of which is information about a thread in which an error has occurred, may be displayed as shapes each having a length along the second axis, corresponding to a thread execution time. In the example illustrated in FIG. 1, the thread information is represented by a rectangle that has a length along a time axis, corresponding to the execution time. However, a shape representing the thread is not limited and may be varied.

In the terms “thread 1,” “thread 2,” “thread 3,” and “thread 4” in FIG. 1, “1”, “2”, “3”, and “4” indicate thread identification information, respectively. An upper line 133 of a grid representing the thread 1 130 represents the starting time of a thread 1 130, and a lower line 134 represents the ending time of the thread 1 130. In similar manner, the starting time and the ending time and error occurrence time of each of the other threads may be displayed in the time information providing region 110.

In the example illustrated in FIG. 1, an information item 170 represented by a processor 1 indicates that the thread 1 130, the thread 2 140, and the thread 3 150 are executed in a processor of which an identification is “1”, and an information item 180 represented by a processor 2 indicates that the thread 4 160 is executed in a processor of which an identification is “2”.

The pieces of thread information of the respective threads 130, 140, 150, and 160 may indicate information items of at least one of threads in which an error occurs, and are provided as indicators 131, 141, 151, and 161 which may be selected according to a user input. In response to receiving a user input signal that selects one of the indicators 131, 141, 151, and 161, the visual interface 100 may provide another visual interface including specified information linked with the selected indicator.

In the example illustrated in FIG. 1, examples of the indicators 131, 141, 151, and 161, each of which is configured to provide specified information of the corresponding thread, are illustrated as small circles. Although the indicators 131, 141, 151, and 161 are shown as circles in FIG. 1, the indicators may be represented by various shapes such as triangles, pentagons, etc. Moreover, the indicators 131, 141, 151, and 161 may be displayed with the same color when they indicate the same memory address, and otherwise, may be displayed with different colors. For example, the indicator 131 and the indicator 161 may be generated by operations which refer the same memory address, and thus may be displayed with the same color. In addition, the indicator 141 and the indicator 151 may be generated by operations which refer to the same memory address, and accordingly may be displayed with the same color. In contrast, the indicator 131 and the indicator 141 may be generated for errors that are produced by operations that refer to different memory addresses, and thus they may be displayed with different colors.

Furthermore, the intensity of colors of the respective indicators 131, 141, 151, and 161 may vary according to the number of error occurrence. The user may set levels according to error occurrence frequency and view more frequent errors first.

An information item corresponding to an error occurrence time of a thread and the information items 170 and 180 about identification information of processors in which each thread is executed may also be configured by indicators which can be selected according to a user input signal. It may be presumed that an indicator that indicates a memory address is referred to as a first indicator, an indicator that indicates an error occurrence time is referred to as a second indicator, and an indicator that indicates processor identification information is referred to as a third indicator.

In response to a user input to select one of the indicators, an additional visual interface may be provided to provide specified information associated with data corresponding to the selected indicator. In addition, various information items about threads may be configured to be selected by a user input signal, and to be connected with visual interfaces that provide specified information associated with a corresponding indicator.

As such, the visual interface for providing thread error information allows intuitive recognition of a time when an error occurs, on which memory address and in which thread, and intuitive acquisition of information of another thread that accesses a memory address in which an error occurs.

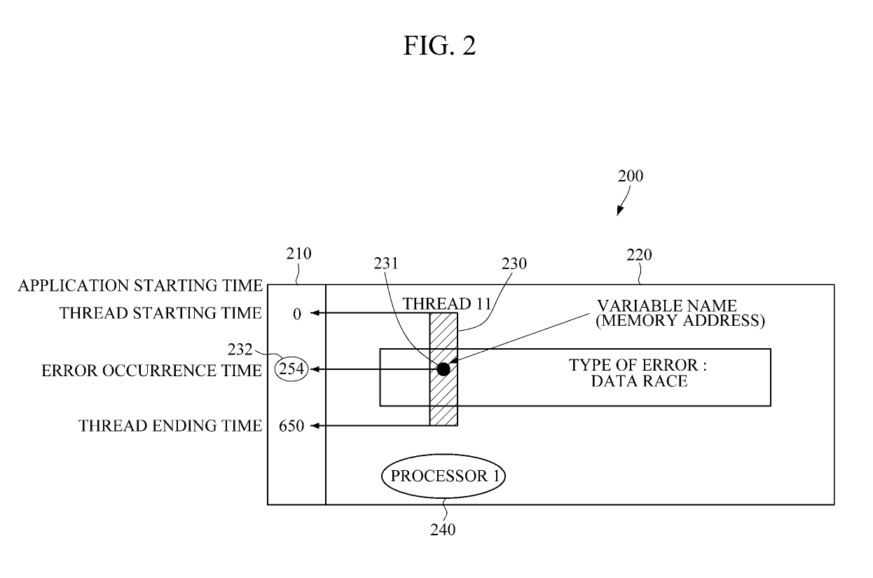

FIG. 2 illustrates an example of a visual interface screen for providing information of errors generated in multiple threads.

The example illustrated in FIG. 2 may be provided as an initial screen of a visual interface 200 for multi-thread error information. When errors occur in multiple threads as shown in FIG. 1, information of one thread may be displayed as an initial screen. A thread displayed on the initial screen may be selected from threads, in each of which an error occurs. For example, a thread in which an error occurs most frequently may be provided in the initial screen, and various modification may be made.

Like the visual interface 100 as shown in the example illustrated in FIG. 1, the visual interface 200 may include a time information providing region 210 and a thread information providing region 220. In addition, the visual interface 200 arranges at least one piece of thread information along a first axis, and provides at least one piece of time information on a second axis that is different from the first axis. The thread information is information about a thread in which an error has occurred, and the time information is information about a time period during which a thread is executed.

The time information providing region 210 may provide an application starting time, a starting time of a thread 11 230, an ending time of the thread 11 230, and an error occurrence time of the thread 11 230. Moreover, the time information providing region 210 may display a second indicator 232 that indicates an error occurrence time. As shown in the example illustrated in FIG. 2, the starting time of the thread 11 230 may be set to “0” and the other time information may be measured based on the set starting time. However, the time information provided in the time information providing region 210 may be represented using various units of time.

The thread information providing region 220 may provide identification information “11” of the thread 11 230, a first indicator 231 that indicates a memory address of the thread 11 230, a type of an error, and a third indicator 240 that indicates identification information of a processor in which the thread 11 230 is executed. Thus, information of a type of an error and information of a processor in which a thread is executed may be provided along with thread execution time information, allowing a user who debugs multi-thread errors to intuitively recognize the error that has occurred in a thread.

Other indicators may be provided corresponding to information items which are associated with information of a thread in which an error has occurred, and the indicators can be selected according to a user input, like the indicators 231, 232, and 240. In response to a user input signal for selecting an indicator, another visual interface that includes specified information of a displayed information item may be provided.

In response to a user input signal for selecting the first indicator 231 that indicates a memory address, information of one or more other threads that share the memory address may be displayed. According to the user input signal for selecting the first indicator 231, threads that are involved in the error occurrence and pieces of information about the threads may be displayed on a screen. The information about the threads may include a memory address, a source code location, an error occurrence time, etc. When two or more threads are displayed, the relationship between the information about the threads may also be displayed using an arrow or the like. At this time, thread information and a memory address which are not relevant to the error are not displayed.

In response to a user input signal for selecting the second indicator 232, a function to which the error is belonging may be displayed. If one function invokes the function to which the error is belonging, the invoking function may be displayed as well. If the function that has invoked the function including the error is included in a different thread, information of the different thread may be additionally displayed.

In response to a user input signal for selecting the third indicator 240 that indicates the identification of a processor in which a thread is executed, information of at least one of other threads that are being executed in the processor may be displayed.

As such, the indicators for the information items related to an error are provided and specified information is provided according to the selection of the indicators, and thus the user can easily retrace error information stepwise and/or sequentially.

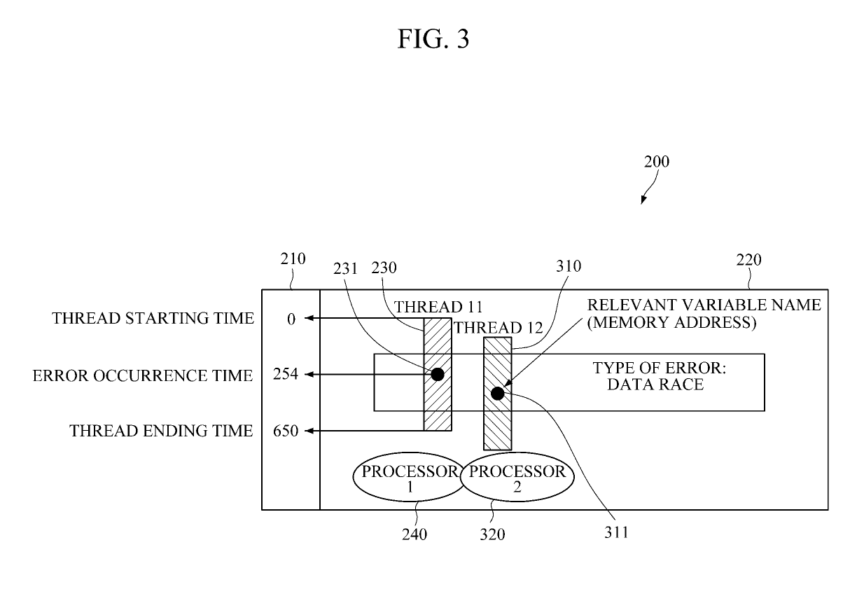

Examples of a visual interface which may be additionally provided according to a type of an indicator will be described with reference to FIGS. 3 to 5.

FIG. 3 illustrates an example of a visual interface screen which is additionally provided in response to selecting a first indicator shown in FIG. 2.

When in the visual interface 200 shown in FIG. 2, a user input signal may be received to select the first indicator 231 that corresponds to a memory address of the thread 11 230 in which an error has occurred, information of at least one of other threads, for example, a thread 12 310 in FIG. 3, that shares the memory address with the thread 11 230 may be displayed together with the information about the thread 11 230.

As such the information about the thread 12 310, a first indicator 311 and a second indicator 312 may be provided. The first indicator 311 may indicate a memory address and the second indicator 312 may indicate identification information of a processor in which the thread 12 310 is executed. In response to selecting either the first indicator 311 or the second indicator 312, additional information corresponding to the selected indicator may be displayed.

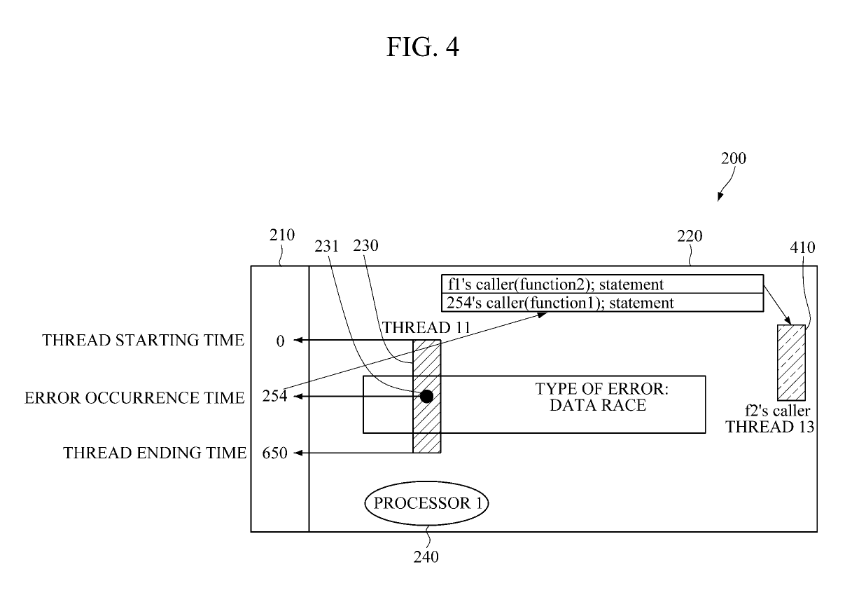

FIG. 4 illustrates an example of a visual interface screen which is additionally provided in response to selecting a second indicator shown in FIG. 2.

When in the visual interface 200 shown in FIG. 2, a user input signal may be received to select the second indicator 232 that corresponds to a time when an error occurred, for example, “254's caller (function1); statement” may be displayed as information to show that function1 includes an error that occurred at time 254. For example, “statement” may represent location information of a source code of a corresponding function. In addition, additional information, “f1's caller (function2); statement”, may be provided to inform that a function, “function 2”, calling function 1. The information of a function in which an error has occurred may be provided in a stack in which a function including the error and another function calling the function are orderly arranged.

In response to a thread, for example, a thread 13 410 as shown in FIG. 4, which has invoked function 2 being different from the thread 11 230, information about the thread 13 410 may be additionally displayed. An indicator (not shown) that indicates time information about a time when an error occurred in the thread 13 410 may be provided. According to a user input signal for selecting the provided indicators, information of a different thread that has invoked the thread 13 410 may be added onto the stack information about “f1' s caller (function2)”, and this operation may be repeated until a root (main) function is reached.

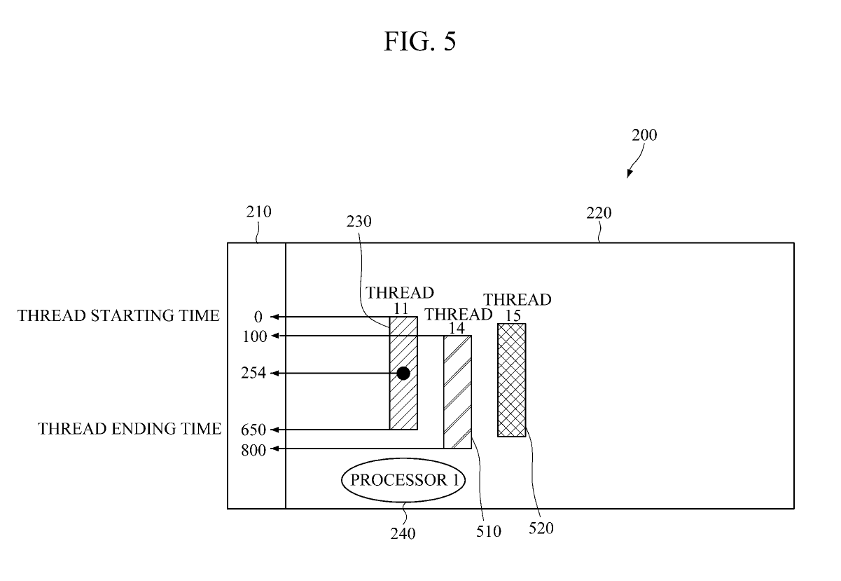

FIG. 5 illustrates an example of a visual interface screen which is additionally provided in response to selecting the third indicator shown in FIG. 2.

When in the visual interface 200 shown in FIG. 2, a user input signal may be received to select the third indicator 240 that corresponds to processor identification information related to the thread 11 230, a visual interface may be provided to additionally display threads other than the thread 11 230 which may be executed in a processor or a core that may be indicated by the third indicator 240, that is, a thread 14 510 and a thread 15 520 in FIG. 5.

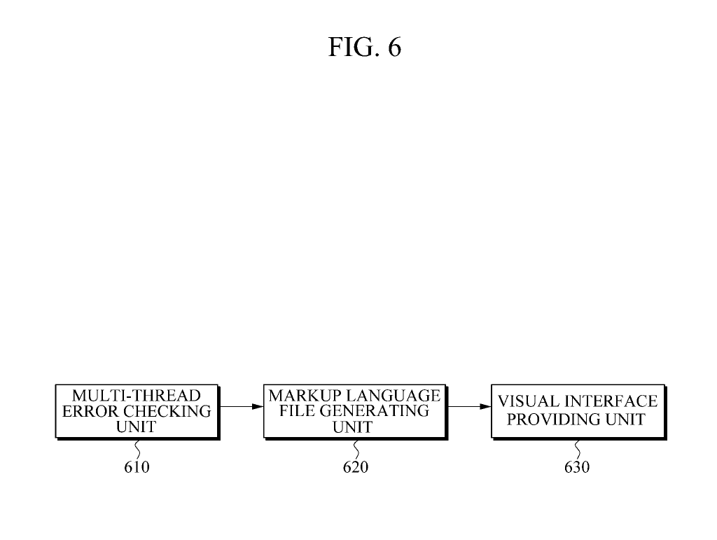

FIG. 6 illustrates an example of a structure of a visual interface providing apparatus for providing information of errors generated in multiple threads.

A visual interface providing apparatus 600 for providing multi-thread error information may include a multi-thread error checking unit 610, a markup language file generating unit 620, and a visual interface providing unit 630.

The multi-thread error checking unit 610 may check one or more that have occurred while program codes are processed in a way of multi-thread. The multi-thread error checking unit 610 may be configured to perform a variety of profiling to analyze abnormal or unintended operations of a program due to mistakes in program design or unpredicted variables.

For example, the multi-thread error checking unit 610 may be implemented as a device that performs binary instrumentation. In binary instrumentation, a compiled binary code of an application in which instrumentation is performed may be modified to an instrumentation code, and the instrumentation code may be executed as a part of the application. The instrumentation code is a set of instructions required to acquire information about operations or events that occur during execution of an application. A set of instructions includes one or more instructions.

The multi-thread error checking unit 610 may receive a source code in a binary format, and create an error log that includes information necessary for providing the visual interface as shown in the above examples. The multi-thread error checking unit 610 may obtain the error log which is detected and analyzed through instrumentation. Additionally, the error log may include the type of an error, an error occurrence time, variable names related to an error address (for example, a memory address, and a code location), call stack information at time of error occurrence, and the like.

The markup language file generating unit 620 may convert the error log information into a markup language file according to a predetermined document type definition. The predetermined document type definition may specify at least one information item related to an error, which is used to provide a visual interface. The predetermined document type definition may define the information items required for the visual interface, and may be displayed as a document that defines types and forms of information to be included in the defined information items. There may be several document type definitions according to criteria such as types of errors.

The predetermined document type definition may include at least one information item which indicates general information of a thread and error information about an error that has occurred in a thread and linkage information to link one markup language file with another markup language file. For example, in the information item with respect to a thread in which an error has occurred, general thread information including <thread identification information>, <thread lifetime>, <thread-allocated-processor identification information>, <at least one memory address used by thread>, <variable name indicating memory address>, <call stack information>, <relationship information between threads>, etc. and error information including <memory address of thread on which error occurs>, <error occurrence time>, <thread-executed-processor identification information>, etc. may be displayed with identification tags in the form of < >. Moreover, a type of the predetermined document type definition may include one type providing summary information of error information and another type providing specified information of the error information.

The markup language file generating unit 620 may produce a document in a markup language format by extracting and obtaining data from the error log where the data corresponds to information items specified according to the predetermined document type definition. A document in a markup language format such as extensible markup language (XML) may further include diverse kinds of visual information that graphically represent information items displayed by the visual interface providing unit 630.

The markup language file generating unit 620 may create a markup language file using a document type definition that is provided through an initial screen or is frequently used by the visual interface providing unit 630. The markup language file generating unit 620 does not need to apply error log information to all of the initially possessed document type definition, but can generate, in real time, a markup language file requested by a user input signal.

The visual interface providing unit 630 renders the markup language file to provide a visual interface. The visual interface providing unit 630 may configure a visual interface screen using general thread information and error information which are included in the markup language file, as shown in FIGS. 1 to 5, and output the visual interface screen to a display device.

The visual interface providing unit 630 arranges at least one piece of thread information on a first axis, and provides time information on a second axis that is different from the first axis, as described with reference to FIGS. 1 to 5. The thread information is information about a thread in which an error has occurred, and the time information is information about a time period during which at least one thread is executed.

The visual interface providing unit 630 may provide one or more indicators corresponding to one or more information items which are associated with information of a thread in which an error has occurred, allowing a user to select the information item through an input made by selecting an indicator. Moreover, the visual interface providing unit 630 may provide another visual interface by loading a markup language file including specified information of the information item indicated by the indicator in response to a user input signal selecting the indicator.

If a markup language file including specified information of an information item corresponding to an indicator selected in response to a user input signal is not previously created, the markup language file generating unit 620 may create a corresponding markup language file according to the user input signal. For example, the loading of the markup language file including the specified information includes loading of information about parts of the currently processed markup language file which have not been represented through the visual interface, in addition to loading of the specified information included in the markup language file. The configuration of providing an additional visual interface according to a user input signal may be implemented in various methods.

The markup language file generating unit 620 and the visual interface providing unit 630 may be operated to display information of at least one of other threads that share a memory address with a current thread in response to a user input signal for selecting a first indicator that indicates the memory address of the current thread in which an error has occurred.

In response to a user input signal for selecting a second indicator that indicates an error occurrence time, a function including the error and another function that has invoked the function may be displayed. In one example, if the other function that has invoked the function is called by another thread, the information of the other thread may be displayed. In response to a user input signal for selecting a third indicator that indicates identification information of a processor in which a thread is executed, information of at least one of other threads that are executed in the processor may be displayed.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

As a non-exhaustive illustration only, the device described herein may refer to mobile devices such as a cellular phone, a personal digital assistant (PDA), a digital camera, a portable game console, and an MP3 player, a portable/personal multimedia player (PMP), a handheld e-book, a portable tablet and/or laptop PC, a global positioning system (GPS) navigation, and devices such as a desktop PC, a high definition television (HDTV), an optical disc player, a setup box, and the like consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of providing information regarding an error generated in multiple threads, the method comprising:
generating error log information about at least one error generated during multi-thread processing of program code;
converting the error log information into a markup language file according to a predetermined document type definition that specifies at least one information item used for a visual interface with respect to an error; and
providing the visual interface by rendering the markup language file, the visual interface comprising:
thread information comprising at least one of general information about at least one thread in which an error has occurred and error information about the error; and
time information about a time period during which the at least one thread is executed.

2. The method of claim 1, wherein the predetermined document type definition comprises at least one information item which indicates:
the general information of a thread or the error information about an error that has occurred in a thread; and
linkage information to link with another markup language file.

3. The method of claim 1, wherein the general information comprises at least one of: thread identification information, thread lifetime and identification information of a processor to which a thread is allocated, at least one memory address that a thread uses, a variable name that indicates the memory address, call stack information, and information of a relationship between threads.

4. The method of claim 1, wherein the error information comprises at least one of a type of error in a thread, error occurrence time, and a memory address on which an error has occurred.

5. The method of claim 1, wherein the providing of the visual interface comprises:
arranging the thread information along a first axis, the general information comprising information about at least one thread in which the error has occurred; and
providing the time information on a second axis which is different from the first axis, the time information comprising information about a time period during which the at least one thread is executed.

6. The method of claim 1, further comprising:
providing one or more indicators, each of which provides the information item regarding at least one thread in which the error has occurred, and which can be selected according to a user input; and
providing another visual interface by loading a markup language file comprising specified information of the information item indicated by the indicator in response to a user input signal for selecting one of the one or more indicators, the specified information being linked with the selected indicator.

7. The method of claim 6, wherein the one or more indicators comprise at least one of a first indicator indicating a memory address on which the error has occurred, a second indicator indicating a time when the error occurred in the thread, and a third indicator indicating identification information of a processor in which the thread is executed.

8. The method of claim 7, further comprising displaying information of at least one of other threads that share the memory address with the thread, in response to a user input signal for selecting the first indicator.

9. The method of claim 7, further comprising:
displaying a function comprising the error and another function that has invoked the function, in response to a user input signal for selecting the second indicator; and
in response to the other function that has invoked the function being called by a different thread, displaying information of the different thread.

10. The method of claim 7, further comprising displaying information of at least one of other threads that are executed in the processor, in response to a user input signal for selecting the third indicator.

11. An apparatus for providing information of an error generated in multiple threads, the apparatus comprising:
an error checking unit configured to generate error log information about at least one error generated during multi-thread processing of program code;
a markup language file generating unit configured to convert the error log information into a markup language file according to a predetermined document type definition specifying at least one information item used for a visual interface with respect to an error; and
a visual interface providing unit configured to provide the visual interface by rendering the markup language file, the visual interface comprising thread information comprising at least one of:
general information about at least one thread in which an error has occurred and error information about the error; and
time information about a time period during which the at least one thread is executed.

12. The apparatus of claim 11, wherein the predetermined document type definition comprises at least one information item configured to indicate:
the general information of a thread or the error information about an error that has occurred in a thread; and
linkage information to link with another markup language file.

13. The apparatus of claim 11, wherein the visual interface providing unit is further configured to:
provide one or more indicators, each of which being configured to provide the information item regarding at least one thread in which the error has occurred, and which can be selected according to a user input; and
provide another visual interface by loading a markup language file comprising specified information of the information item indicated by the indicator in response to a user input signal for selecting one of the one or more indicators, the specified information being linked with the selected indicator.

14. The apparatus of claim 13, wherein the one or more indicators comprise at least one of: a first indicator configured to indicate a memory address on which the error has occurred, a second indicator configured to indicate a time when the error occurred in the thread, and a third indicator configured to indicate identification information of a processor in which the thread is executed.

15. The apparatus of claim 14, wherein the visual interface providing unit is further configured to display information of at least one of other threads that share the memory address with the thread, in response to a user input signal for selecting the first indicator.

16. The apparatus of claim 14, wherein the visual interface providing unit is further configured to:
display a function comprising the error and another function that has invoked the function, in response to a user input signal for selecting the second indicator; and
in response to the other function that has invoked the function being called by a different thread, display information of the different thread.

17. The apparatus of claim 14, wherein the visual interface providing unit is further configured to display information of at least one of other threads that are executed in the processor, in response to a user input signal for selecting the third indicator.

18. A computer-readable information storage medium storing a program that, when executed, causes the computer to perform a method, comprising:
generating error log information about at least one error generated during multi-thread processing of program code;
converting the error log information into a markup language file according to a predetermined document type definition that specifies at least one information item used for a visual interface with respect to an error; and
providing the visual interface by rendering the markup language file, the visual interface comprising:
thread information comprising at least one of general information about at least one thread in which an error has occurred and error information about the error; and
time information about a time period during which the at least one thread is executed.
